(19) United States
(12) Patent Application Publication
(10) Pub. No.: US 2026/0193921 A1
(43) Pub. Date: Jul. 9, 2026

(54) GUIDE SYSTEM FOR GUIDING AT LEAST ONE MOVABLY MOUNTED DOOR LEAF

(71) Applicant: Julius Blum GmbH, Hoechst (AT)

(72) Inventors: Thomas FOLIE, Dornbirn (AT); Manuel SCHMITT, Hoechst (AT); André HAMMERER, Alberschwende (AT); Markus IRGANG, Altach (AT)

(21) Appl. No.: 19/553,970

(22) Filed: Mar. 2, 2026

Related U.S. Application Data
(63) Continuation of application No. PCT/AT2024/060307, filed on Aug. 14, 2024.

(30) Foreign Application Priority Data
Sep. 7, 2023 (AT) A 50718/2023

(51) Int. Cl. E05D 15/58; E05D 15/26

(52) U.S. Cl. CPC E05D 15/581; E05D 15/264; E05Y 2201/64; E05Y 2201/684; E05Y 2900/212

(57) ABSTRACT

A guide system includes a first guide rail for guiding a door wing, a running carriage to be connected to the door wing and displaceable along the first guide rail, and a carrier on which the running carriage can be arranged. The carrier is movable along a second guide rail extending transversely to the longitudinal direction of the first guide rail. The carrier is movable into a transfer position in which the carrier adjoins the first guide rail in a longitudinal direction such that the running carriage can be transferred to and from between the first guide rail and the carrier. A deflection device with a control curve converts a movement of the carrier along the second guide rail into a movement of the running carriage along the first guide rail, and the control curve of the deflection device and the second guide rail are substantially in a common plane.

The present application is a continuation of International Application PCT/AT2024/060307 filed on Aug. 14, 2024. Thus, all of the subject matter of International Application PCT/AT2024/060307 is incorporated herein by reference.

### BACKGROUND OF THE INVENTION

The present invention relates to a guide system for guiding at least one movably-supported door wing, the guide system comprising:
at least one first guide rail having a longitudinal direction for guiding the at least one door wing,
at least one running carriage which is to be connected to the at least one door wing and which is displaceable along the first guide rail, and
at least one carrier on which the at least one running carriage can be arranged, the carrier being movable along at least one second guide rail, the at least one second guide rail extending transversely to the longitudinal direction of the first guide rail, wherein the carrier, in a mounted position, is movable into a transfer position, in which the carrier adjoins the at least one first guide rail in a longitudinal direction such that the running carriage can be transferred to and from between the first guide rail and the carrier.

Further, the invention concerns an item of furniture comprising a furniture carcass, at least one door wing movable relative to the furniture carcass, and at least one guide system of the type to be described for guiding the at least one door wing relative to the furniture carcass.

WO 2020/097656 A1 discloses a guide system for guiding door wings. The door wings are movable by the guide system between a first position, in which the door wings are aligned substantially coplanar to each other, and a second position, in which the door wings are aligned substantially parallel to each other. In order to improve the transition of the door wings between the coplanar position and the parallel position, a curved control contour is provided along which a running wheel of a running carriage to be connected to a door wing is displaceable. The curved control contour is arranged on a first end region of a first guide rail, which is to be arranged parallel to a front face of the furniture carcass. The control contour is formed integrally with the first guide rail or, alternatively, is arranged on an adaptor portion that can be connected to the first guide rail. In addition, a second guide rail is provided, along which the two door wings, when aligned parallel to each other, are movable in a depth direction of the furniture carcass.

A drawback with the prior art is the fact that the components of the guide system must be arranged on the first guide rail, on the furniture carcass, and on the carrier. Therefore, there arises the difficulty that the coordination of the components relative to each other and the assembly of the guide system are associated with several challenges.

Another drawback is the fact that the running carriage, in a transition region between the two guide rails, often does not have sufficient speed in order to provide a smooth and dynamic movement of the running carriage in the transition region. This can cause the door wing to move jerkily in the transition region, accompanied by unpleasant noises.

### SUMMARY OF THE INVENTION

It is an object of the present invention to propose an improved guide system in view of the prior art, thereby avoiding the above-discussed drawbacks.

According to the invention, a deflection device with at least one control curve is provided, the deflection device being configured to convert a movement of the at least one carrier along the at least one second guide rail into a movement of the running carriage along the at least one first guide rail. At least the control curve of the deflection device and the at least one second guide rail are arranged substantially in a common plane.

In other words, a deflection device is provided which converts a movement of the carrier into a drive movement so as to drive the running carriage at least over a region along the first guide rail.

When the running carriage is moved in the opposite direction, thus from the first guide rail in a direction of the second guide rail, then the deflection device converts a movement of the running carriage into a drive movement so as to drive the carrier at least over a region along the second guide rail.

In addition, at least the control curve of the deflection device and the at least one second guide rail are arranged substantially in a common plane above each other. In this way, the deflection device is assigned to the second guide rail, so that it is no longer necessary to mount the deflection device on the first guide rail.

Each of the deflection device and the second guide rail can be substantially plate-shaped at least over a region, or can be substantially cuboidal. At least the control curve of the deflection device and the second guide rail are arranged substantially in a common plane above each other in a mounted condition.

The proposed invention makes it possible to pre-assemble the guide system substantially entirely on the item of furniture, so that a perfect coordination of the components with each other and a simple subsequent installation of the door wing on the pre-assembled guide system can be made possible.

### BRIEF DESCRIPTION OF THE DRAWINGS

Further details and advantages of the present invention will be apparent from the following description with reference to the drawings, in which:

FIG. 1a, 1b are perspective views of an item of furniture comprising a furniture carcass and door wings movable relative thereto,

FIG. 2a, 2b show the item of furniture according to FIGS. 1a, 1a in further positions of the door wings relative to each other,

FIG. 3 shows the guide system in a perspective view,

FIG. 4a, 4b show the guide system in two different perspective views,

FIG. 5a, 5b show the guide system in a perspective view and an enlarged detail view thereof,

FIG. 6a-6c show the guide system in a further position of the control lever and enlarged detail views thereof,

FIG. 7 shows the deflection device in an exploded view, and

FIG. 8a, 8b show the guide system with two different adjustment options in perspective views.

### DETAILED DESCRIPTION OF THE INVENTION

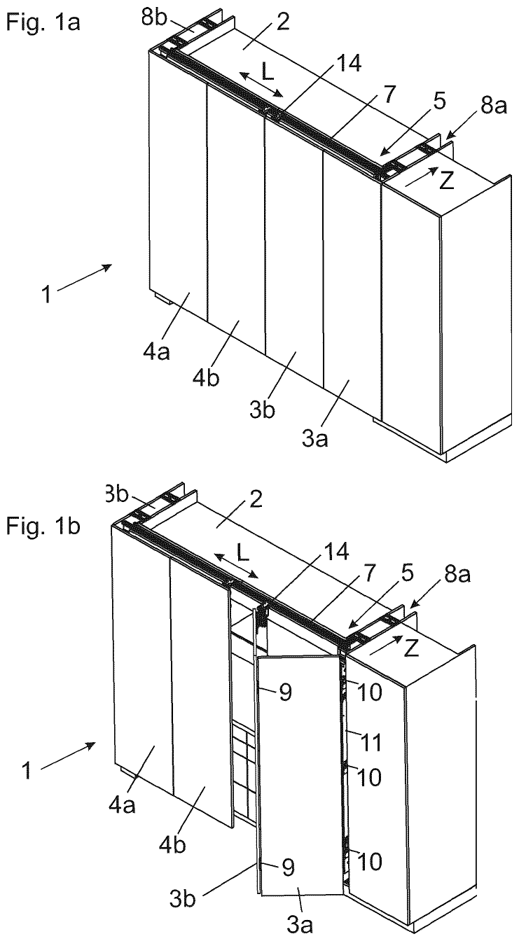

FIG. 1a shows a perspective view of an item of furniture 1 comprising a furniture carcass 2 and at least one door wing 3a, 3b; 4a, 4b movably supported relative to the furniture carcass 2.

In the shown embodiment, a folding-sliding-door is provided, in which the door wing 3a and the door wing 3b are hingedly connected to each other via a vertically extending first pivoting axis. The two other door wings 4a, 4b are hingedly connected to each other via a vertically extending second pivoting axis.

The door wings 3a, 3b and the door wings 4a, 4b are movable by a guide system 5 between a first position, in which the door wings 3a, 3b; 4a, 4b are aligned substantially coplanar to each other, and a second position, in which the doors wings 3a, 3b; 4a, 4b are aligned substantially parallel to each other.

The door wings 3a, 3b, in the second (parallel) position, are insertable into a lateral receiving compartment 8a of the furniture carcass 2, whereas the two other door wings 4a, 4b, in a parallel position to each other, are insertable into a further receiving compartment 8b.

The functionality will be explained in the following with the aid of the door wings 3a, 3b, and the same explanations are valid for the door wings 4a, 4b.

The guide system 5 includes a first guide rail 7 having a longitudinal direction L, and a running carriage 14 to be coupled to the second door wing 3b is displaceably supported along the first guide rail 7. The first guide rail 7, in a mounted position, is arranged substantially horizontally and parallel to a front edge of the furniture carcass 2.

FIG. 1b shows the item of furniture 1, in which the door wings 3a, 3b have been moved from the coplanar position shown in FIG. 1a into an angled position relative to each other. For example, the first door wing 3a can be pivotally supported on a carrier 11 via two or more furniture hinges 10. The carrier 11 (together with the two door wings 3a, 3b) is insertable into the receiving compartment 8a in a depth direction Z.

The carrier 11, in the shown figure, is located in a transfer position so as to transfer the running carriage 14 to and from between the first guide rail 7 and the carrier 11. In the shown transfer position, the carrier 11 is releasably locked relative to the first guide rail 7, and the locking of the carrier 11 is releasable by an entry of the running carriage 14 in or on the carrier 11. The carrier 11 is in the form of a longitudinally extending column, the length of which corresponding to at least half of a height of the door wings 3a, 3b.

The two door wings 3a, 3b are hingedly connected to each other by at least one hinge fitting 9 via a pivoting axis extending vertically in the mounted position. The second door wing 3b is displaceably guided along the first guide rail 7 via the running carriage 14.

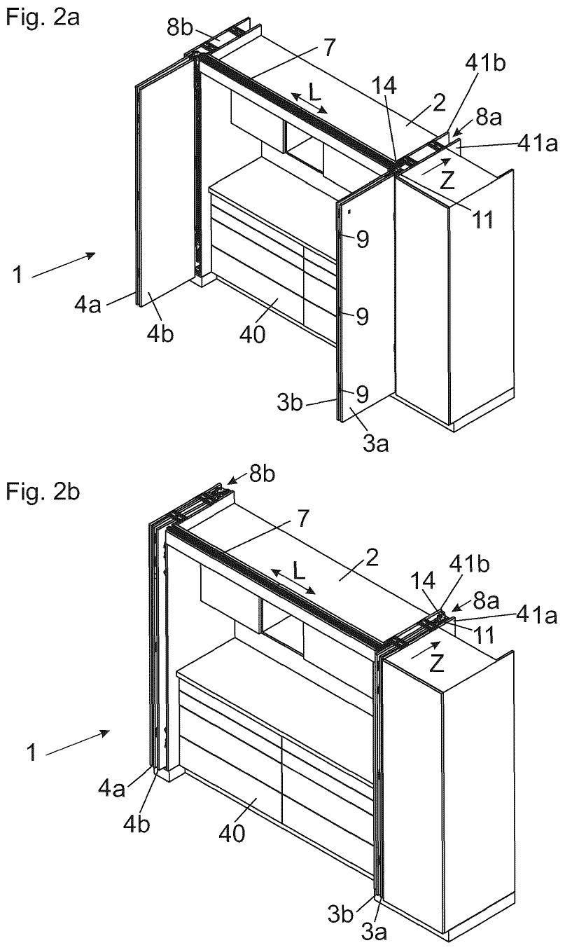

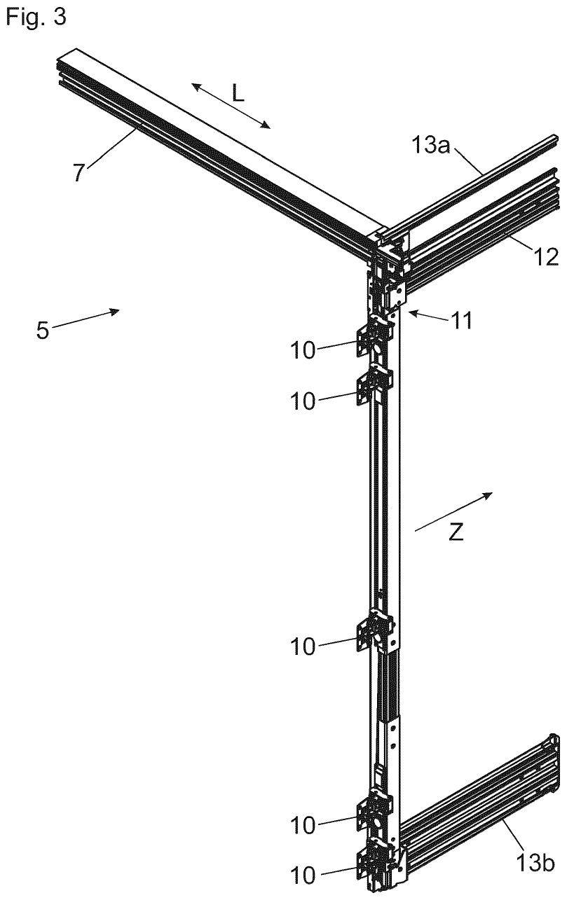

FIG. 2a shows the item of furniture 1 with the door wings 3a, 3b which are now aligned parallel to each other. The carrier 11 has been unlocked from the first guide rail 7 by an entry of the running carriage 14, so that the carrier 11 (together with the running carriage 14 and the door wings 3a, 3b) is insertable into the receiving compartment 8a along at least one second guide rail 12 (FIG. 3) of the guide system 5, the second guide rail 12 extending transversely to the longitudinal direction L of the first guide rail 7.

FIG. 2b shows the item of furniture 1 with the door wings 3a, 3b which are now located in a fully inserted condition within the receiving compartment 8a. The door wings 3a, 3b are thus movably supported by the guide system 5 between a first position according to FIG. 1a, in which the door wings 3a, 3b are aligned substantially coplanar to each other, and a second position according to FIG. 2b, in which the door wings 3a, 3b are aligned substantially parallel to each other and can be accommodated within the receiving compartment 8a. In this way, for example, a kitchen 40 as shown in FIGS. 2a, 2b can be entirely covered, so that the kitchen 40 can be visually separated from a remaining area of a living room.

In the shown embodiment, the receiving compartment 8a is formed by a first furniture panel 41a and by a second furniture panel 41b spaced apart from the first furniture panel 41a in a substantially parallel relationship. The door wings 3a, 3b, in a parallel position to each other, can be received between the two furniture panels 41a, 41b.

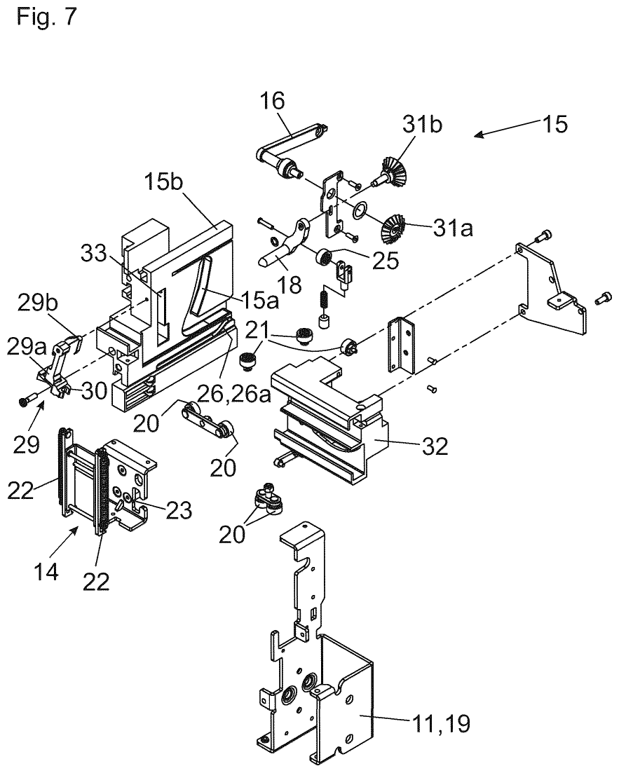

FIG. 3 shows the guide system 5 in a perspective view. By the first guide rail 7, the door wings 3a, 3b are guidable along a front face of the furniture carcass 2. The carrier 11 is configured for the pivotal support of the first door wing 3a, and can include at least two or more furniture hinges 10 spaced apart from each other in a longitudinal direction of the carrier 11. The carrier 11 is displaceably supported in the depth direction Z along at least one second guide rail 12. The carrier 11 can include at least one rolling body 21 (FIG. 7) which is displaceably supported along the at least one second guide rail 12. Preferably, the carrier 11 includes a plurality of rolling bodies 21 rotationally supported about a horizontally extending axis in the mounted position and/or rotationally supported about a vertically extending axis in the mounted position, the rolling bodies 21 being configured to roll along the at least one second guide rail 12.

In the shown embodiment, at least one further second guide rail 13a, 13b is provided, the at least one further second guide rail 13a, 13b being spaced apart from the at least one second guide rail 12 in a height direction.

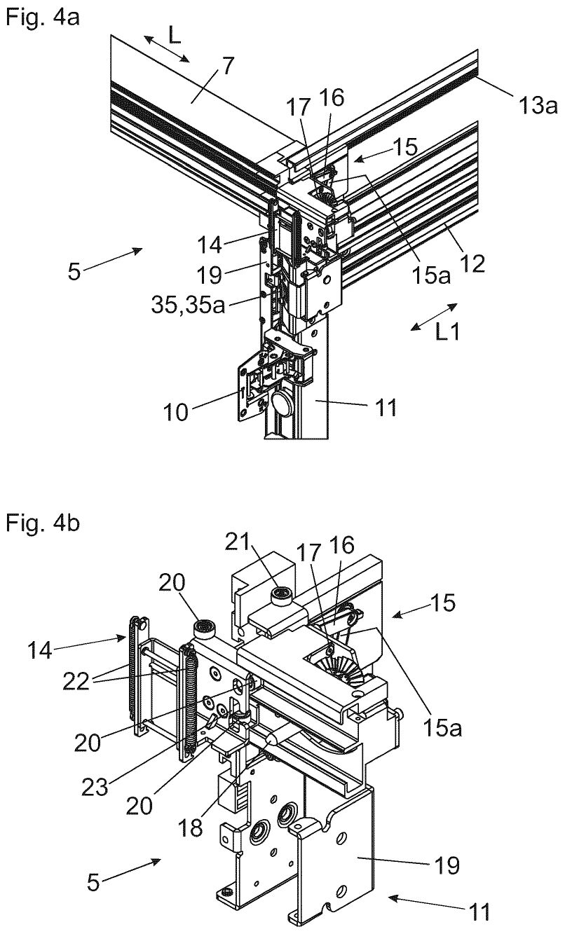

FIG. 4a shows a partial region of the guide system 5 in a perspective view. The guide system 5 includes at least two guide rails 7, 12 extending transversely relative to each other. At least one furniture hinge 10 for pivotally supporting the first door wing 3a is arranged on the carrier 11, and the carrier 11 is movably supported along the second guide rail 12 in the depth direction Z. The second door wing 3b is to be connected to the running carriage 14 which can be arranged on the carrier 11 and which is movably supported along the first guide rail 7. In the shown figure, the carrier 11 is located in a transfer position in which the carrier 11 adjoins the first guide rail 7 in a longitudinal direction L so as to transfer the running carriage 14 to and from between the first guide rail 7 and the carrier 11.

In the shown transfer position, the carrier 11 is releasably locked with the first guide rail 7. The locking between the first guide rail 7 and the carrier 11 is releasable by an entry of the running carriage 14 in or on the carrier 11.

A deflection device 15 with at least one control curve 15a is provided, the deflection device 15 being configured to convert a movement of the at least one carrier 11 along the at least one second guide rail 12 into a movement of the running carriage 14 along the at least one first guide rail 7. At least the control curve 15a of the deflection device 15 and the at least one second guide rail 12 are arranged substantially in a common plane.

At least one pivotable control lever 16 is provided on the carrier 11, the control lever 16 being movably supported along the control curve 15a of the deflection device 15. The carrier 11 is movably supported relative to the second guide rail 12 between a retracted end position and an extended end position. The control lever 16, shortly before the carrier 11 reaches the extended end position, enters into the control curve 15a of the deflection device 15. A pivotal movement of the control lever 16 is converted by a transmission device 17 into a movement of an ejection lever 18 (FIG. 4b), and the running carriage 14 can be driven by the ejection lever 18 at least over a region along the first guide rail 7. As a result, a smooth and dynamic transition movement of the door wings 3a, 3b between the guide rails 7, 12 can be provided in both movement directions.

The carrier 11 includes at least one guide device 19 configured to guide the carrier 11 along the second guide rail 12. In the shown embodiment, at least one adjustment device 35 is provided for adjusting the carrier 11 relative to the at least one guide device 19. The adjustment device 35 can include at least one rotatable adjustment element 35a, and a position of the carrier 11 relative to the guide device 19 is adjustable by rotating the adjustment element 35a, preferably in at least one direction extending transversely to the longitudinal direction L1 of the second guide rail 12. For example, the adjustment device 35 can include a worm gear and/or an eccentric. The adjustment element 35a of the adjustment device 35 can include a receiving contour for a tool, for example for a screwdriver.

FIG. 4b shows a partial region of the guide system 5 according to FIG. 4a. The carrier 11 includes a guide device 19 configured to guide the carrier 11 along the second guide rail 12. The control lever 16 pivotally supported on the carrier 11 is movably supported along the control curve 15a of the deflection device 15. A pivotal movement of the control lever 16 is converted by a transmission device 17 into a movement of the ejection lever 18 so as to drive the running carriage 14 by the ejection lever 18.

By the transmission device 17, the control lever 16 and the ejection lever 18 can be coupled to each other. For example, the transmission device 17 can include at least one angular gear, at least one cardan joint, and/or at least one V-belt transmission.

The ejection lever 18 is pivotally supported in a first pivot plane, and the control lever 16 is pivotally supported in a second pivot plane. The first pivot plane and the second pivot plane extend substantially at a right angle to each other.

The running carriage 14 to be connected to the door wing 3b includes a plurality of running wheels 20 which can roll along the first guide rail 7 and which are rotatably supported about a vertically extending rotational axis in the mounted position and/or about a horizontally extending rotational axis in the mounted position.

The running carriage 14 includes at least one force storage member 22 for pressurizing the door wing 3b in a mounted position with a force opposite the weight force. By this measure, it is possible to reduce a sagging movement of the door wing 3b, in particular in an intermediate position between the coplanar position and the parallel position with the first door wing 3a. The running carriage 14 includes at least one ejection contour 23 configured to be engaged with the ejection lever 18 arranged on the carrier 11. The carrier 11 includes at least one rolling body 21 which can roll along the guide rail 13a (FIG. 4a). The guide rail 13a can include a U-shaped profile, and the at least one rolling body 21 is received within the U-shape of the guide rail 13a.

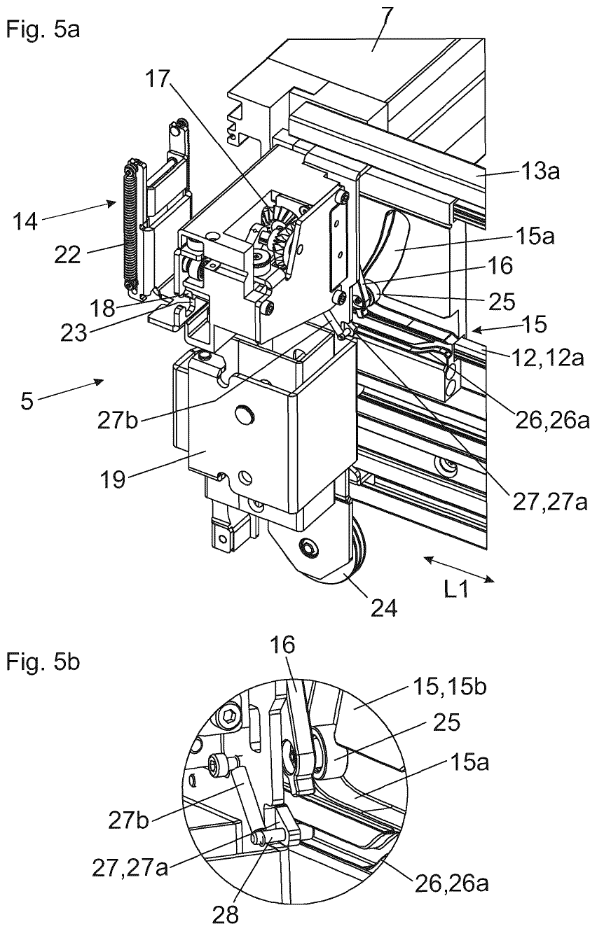

FIG. 5a shows the guide system 5 in a perspective view, in which the guide rails 7, 12 extending transversely relative to each other can be recognized. The carrier 11 is movably supported along the second guide rail 12 via the guide device 19. The control lever 16 arranged on the carrier 11 is movable along the control curve 15a of the deflection device 15, and the deflection device 15 is arranged on a front-end region of the second guide rail 12.

According to possible embodiments, the control curve 15a of the deflection device 15:
is substantially L-shaped, and/or
has an end which is open in a direction of the second rail 12, preferably the open end is arranged substantially parallel to a longitudinal direction L1 of the second guide rail 12, and/or
has a closed end, preferably the closed end is arranged in a direction extending transversely to the longitudinal direction L1 of the second guide rail 12.

According to possible embodiments:
the control lever 16 includes at least one rolling body 25 which is movable along the control curve 15a, and/or
a holding device 27 arranged on the carrier 11 is provided, the holding device 27 being configured to hold the at least one control lever 16 in a ready position, preferably the holding device 27 including at least one holding lever 27a pressurized by a spring 27b.

The second guide rail 12 includes at least one running surface 12a, and the rolling body 25 of the control lever 16 is displaceable along the running surface 12a of the second guide rail 12.

The carrier 11 is movable along the second guide rail 12 between an inner end position and an outer end position. The control lever 16 is held, over a large part between the two end positions, by the holding device 27 in the ready position, that is to say in a locked position relative to the carrier 11. The holding device 27 includes a holding lever 27a which is pre-stressed by a spring 27b, in the present case by a tension spring. The control lever 16 is lockable in the ready position by the holding lever 27a.

Shortly before reaching the outer end position of the carrier 11, the rolling body 25 of the control lever 16 engages with the control curve 15a of the deflection device 15, whereupon the control lever 16 can be unlocked by an unlocking device 26, preferably having an unlocking contour 26a, so as to release the control lever 16 for a pivotal movement.

In the shown embodiment, the holding lever 27a of the holding device 27 enters into an inclinedly extending section of the unlocking contour 26a, whereby the holding lever 27a is lowered, the control lever 16 is unlocked, and the spring 27b is tensioned. By this unlocking operation, the control lever 16 can be released so as to be moved along the control curve 15a of the deflection device 15. A pivotal movement of the control lever 16 is converted via a transmission device 17 into a drive movement of the ejection lever 18, and the running carriage 14 can be driven by the ejection lever 18.

In the shown embodiment, the transmission device 17 includes two bevel gears 31a, 31b (FIG. 7) meshing with each other. A first bevel gear 31a is coupled to the control lever 16, and the other bevel gear 31b is coupled to the ejection lever 18. The transmission device 17 offers the opportunity to vary the transmission ratio, for example in such a way that a movement of the control lever 16 is converted into a movement of the ejection lever 18 with high torque.

The running carriage 14 includes at least one ejection contour 23 configured to be engaged with the ejection lever 18 arranged on the carrier 11. The carrier 11 can include at least one deflection roller 24 for stabilizing the carrier 11 by means of a cable pulley.

FIG. 5b shows an enlarged detail view of FIG. 5a. The deflection device 15 can include a housing 15b, and the control curve 15a is formed or arranged in or on the housing 15b. The housing 15b of the deflection device 15 can be cuboidal at least over a region.

The rolling body 25 of the control lever 16, in the shown figure, bears against a bend of the control curve 15a. The holding lever 27a of the holding device 27 for releasably holding the control lever 16 is supported on a pin 28, the pin 28 being displaceably supported along the unlocking contour 26a of the unlocking device 26.

Upon an entry of the pin 28 into the inclinedly extending section of the unlocking contour 26a, the holding lever 27a is lowered, and the control lever 16 is released for a pivotal movement. The spring 27b engages the pin 28, the spring 27b pressurizing the holding lever 27a in a direction in which the control lever 16 can be locked.

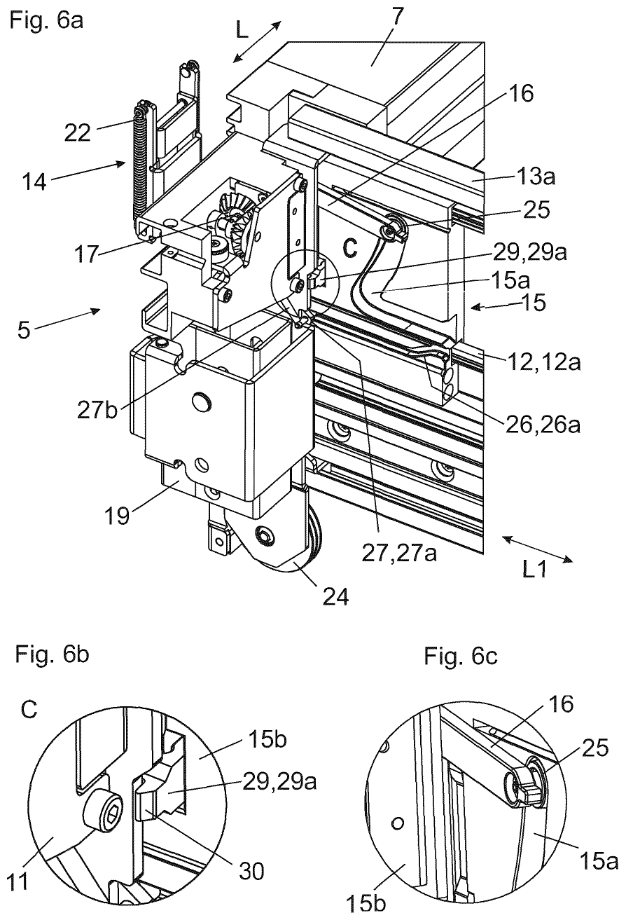

FIG. 6a shows the guide system 5 in a further position of the control lever 16 which is now located on the, preferably closed, end of the control curve 15a. Starting from the position according to the previously shown FIG. 5a, the carrier 11 has further been moved in a direction of the extended position. The control lever 16 has been moved along the section of the control curve 15a extending inclinedly to the longitudinal direction L1. By a pivotal movement of the control lever 16, the ejection lever 18 (not shown here) can be driven via the transmission device 17. The ejection lever 18 pushes the running carriage 14 at least over a region along the first guide rail 7.

The deflection device 15 includes at least one locking device 29 configured to releasably lock the carrier 11 relative to the deflection device 15 in an end position on the at least one second guide rail 12. The locking device 29 has the purpose to lock the carrier 11 in the transfer position. In the transfer position, the carrier 11 adjoins the first guide rail 7 in the longitudinal direction L such that the running carriage 14 can be transferred to and from between the carrier 11 and the first guide rail 7.

The locking between the deflection device 15 and the carrier 11 is again releasable by an entry of the running carriage 14 in or on the carrier 11, so that the carrier 11 (together with the running carriage 14 and the door wings 3a, 3b) is movable in a direction of the retracted end position relative to the second guide rail 12.

FIG. 6b shows the encircled region “C” of FIG. 6a in an enlarged view.

The locking device 29 for releasably locking the carrier 11 relative to the deflection device 15 includes at least one pivotable locking lever 29a which is pre-stressed by a spring element 29b (FIG. 7). The locking lever 29a includes at least one inclined surface 30 for pushing the locking lever 29a into the housing 15b of the deflection device 15 against a force of the spring element 29b.

Upon a movement of the carrier 11 in a direction of the extended end position, the inclined surface 30 is contacted by the carrier 11, and the locking lever 29a is urged into the housing 15b of the deflection device 15 against a force of the spring element 29b. When the carrier 11 reaches the transfer position, then the carrier 11 can be automatically locked by the spring-loaded locking lever 29a.

FIG. 6c shows the region of the control lever 16 according to FIG. 6a in an enlarged view. In the shown figure, the rolling body 25 of the control lever 16 is located on the closed end of the control curve 15a.

The housing 15b of the deflection device 15 can be substantially cuboidal at least over a region, and/or can be arranged, at least over a region, in a common plane with the second guide rail 12.

FIG. 7 shows the deflection device 15 in an exploded view. The control lever 16 displaceable along the control curve 15a is connected in a movement-coupled manner to the ejection lever 18 via the transmission device 17. In the shown embodiment, the transmission device 17 includes two bevel gears 31a, 31b meshing with each other.

The housing 15b of the deflection device 15 includes a recess 33 in which the locking lever 29a of the locking device 29 for releasably locking the carrier 11 relative to the housing 15b of the deflection device 15 can be, substantially entirely, received. The locking lever 29a is pre-stressed by at least one spring element 29b in a direction of a locking position. For example, the spring element 29b can be formed by a leaf spring.

The carrier 11 includes a receiving device 32 configured to receive the running carriage 14. The receiving device 32 of the carrier 11 is displaceable along the at least one second guide rail 12 and/or along the further second guide rail 13a, 13b via a plurality of rolling bodies 21.

The deflection device 15 can include at least one damping device 34 for dampening a movement of the carrier 11. The at least one damping device 34 can include at least one, preferably hydraulic, piston-cylinder-unit. In the shown embodiment, the damping device 34 includes at least two linear dampers switched in parallel in order to dampen a movement of the carrier 11 into the extended end position relative to the second guide rail 12.

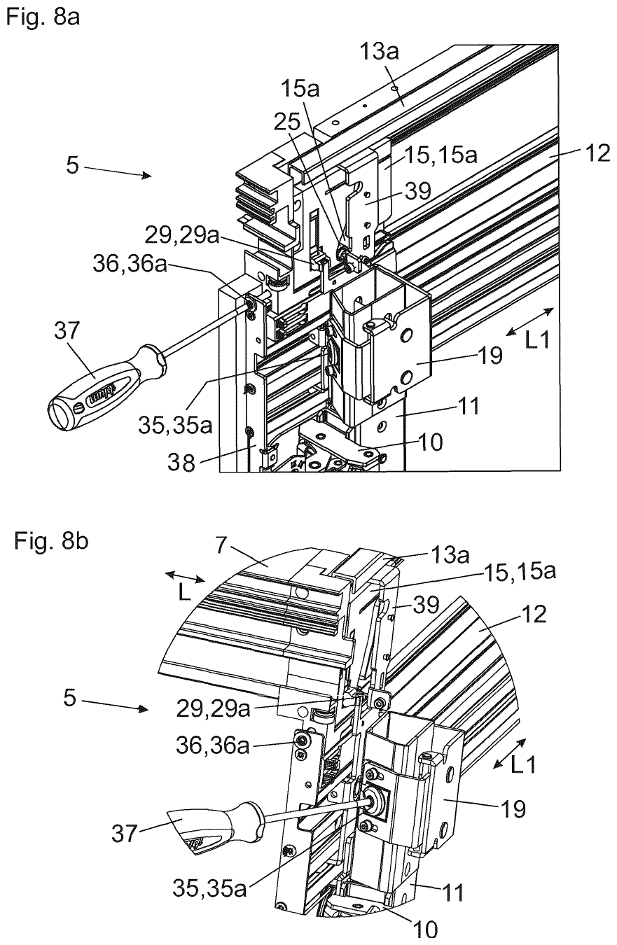

FIG. 8a shows the guide system 5 in a perspective view, in which a position of the deflection device 15 relative to the second guide rail 12 is adjustable by an adjustment device 36, preferably in a direction extending in a longitudinal direction L1 of the second guide rail 12.

The adjustment device 36 can include at least one rotatably supported adjustment element 36a, and a position of the deflection device 15 relative to the second guide rail 12 is adjustable by rotating the adjustment element 36a with the aid of a tool 37, preferably with a screwdriver. In the shown embodiment, the adjustment element 36a of the adjustment device 36 can be actuated from a frontal front face 38 of the second guide rail 12. This offers a comfortable and easily accessible actuation of the adjustment element 36a.

FIG. 8b shows the guide system 5 in a further perspective view, in which a position of the carrier 11 relative to the guide device 19 is adjustable by a further adjustment device 35, preferably in a direction extending transversely to the longitudinal direction L1 of the second guide rail 12.

The further adjustment device 35 includes a rotatably supported adjustment element 35a, and a position of the carrier 11 relative to the guide device 19 is adjustable by rotating the adjustment element 35a with the aid of a tool 37, preferably with a screwdriver. The adjustment element 36a of the adjustment device 36 and/or the adjustment element 35a of the further adjustment device 35 can include a receiving contour for a tool 37.

In the shown embodiment, the guide device 19 includes an upwardly projecting boom 39, the boom 36 being displaceably supported along the guide rail 13a via at least one rolling body 21 (FIG. 4b).

In the shown embodiment, the housing 15b of the deflection device 15 has a U-shaped configuration, and at least a second guide rail 12, 13a can be received within the U-shape of the housing 15b.

Preferably, the two limbs of the U-shape have a maximum thickness corresponding substantially to a maximum thickness of the furniture panel 41b (FIG. 2b).

1. A guide system for guiding at least one movably-supported door wing, the guide system comprising:
at least one first guide rail having a longitudinal direction for guiding the at least one door wing,
at least one running carriage which is to be connected to the at least one door wing and which is displaceable along the first guide rail, and
at least one carrier on which the at least one running carriage can be arranged, the carrier being movable along at least one second guide rail, the at least one second guide rail extending transversely to the longitudinal direction of the first guide rail, wherein the carrier, in a mounted position, is movable into a transfer position in which the carrier adjoins the at least one first guide rail in a longitudinal direction such that the running carriage can be transferred to and from between the first guide rail and the carrier,
wherein a deflection device with at least one control curve is provided, the deflection device being configured to convert a movement of the at least one carrier along the at least one second guide rail into a movement of the running carriage along the at least one first guide rail, wherein at least the control curve of the deflection device and the at least one second guide rail are arranged substantially in a common plane.

2. The guide system according to claim 1, wherein at least one adjustment device is provided for adjusting a position of the deflection device relative to the second guide rail, preferably wherein the adjustment device includes at least one rotatably supported adjustment element configured to be actuated from a front face of the second guide rail.

3. The guide system according to claim 1, wherein the control curve of the deflection device:
is substantially L-shaped, and/or
has an end which is open in a direction of the second rail, preferably wherein the open end is arranged substantially parallel to a longitudinal direction of the second guide rail, and/or
has a closed end, preferably wherein the closed end is arranged in a direction extending transversely to the longitudinal direction of the second guide rail.

4. The guide system according to claim 1, wherein the deflection device includes at least one unlocking device, preferably having an unlocking contour, for unlocking a holding device for a control lever arranged on the carrier.

5. The guide system according to claim 1, wherein the deflection device includes at least one locking device configured to releasably lock the carrier relative to the deflection device in an end position on the at least one second guide rail.

6. The guide system according to claim 1, wherein the deflection device includes at least one damping device for dampening a movement of the carrier, preferably wherein the at least one damping device includes at least one piston-cylinder-unit.

7. The guide system according to claim 1, wherein at least one control lever arranged on the carrier is provided, the control lever being movable along the control curve of the deflection device, preferably wherein:
the control lever has at least one rolling body movable along the control curve, and/or
a holding device arranged on the carrier is provided for holding the at least one control lever in a ready position, preferably wherein the holding device includes at least one holding lever pressurized by a spring.

8. The guide system according to claim 1, wherein at least one ejection lever arranged on the carrier is provided for driving the running carriage at least over a region along the first guide rail.

9. The guide system according to claim 7, wherein at least one transmission device is provided, the at least one transmission device being configured to couple the at least one control lever and the at least one ejection lever to each other, preferably wherein the at least one transmission device includes at least one angular gear, at least one cardan joint, and/or at least one V-belt transmission, preferably wherein the ejection lever is pivotally supported in a first pivot plane and the at least one control lever is pivotally supported in a second pivot plane, wherein the first pivot plane and the second pivot plane extend at a right angle to each other.

10. The guide system according to claim 1, wherein the deflection device is configured to convert a movement of the at least one running carriage along the at least one first guide rail into a movement of the at least one carrier along the second guide rail.

11. The guide system according to claim 1, wherein the running carriage includes at least one ejection contour configured to be engaged with at least one ejection lever arranged on the carrier.

12. The guide system according to claim 1, wherein the carrier includes at least one guide device for guiding the carrier on the second guide rail, preferably wherein at least one adjustment device is provided for adjusting the carrier relative to the at least one guide device, preferably wherein the adjustment device includes at least one rotatable adjustment element.

13. The guide system according to claim 1, wherein the carrier:
includes at least one deflection roller for a cable pulley stabilization of the carrier, and/or
includes at least one furniture hinge for movably supporting the at least one door wing.

14. An item of furniture comprising a furniture carcass, at least one door wing movable relative to the furniture carcass, and at least one guide system according to claim 1 for guiding the at least one door wing relative to the furniture carcass, preferably wherein the item of furniture includes at least one receiving compartment for at least partially receiving the at least one door wing.

15. The item of furniture according to claim 14, wherein at least one second door wing is provided, the second door wing being hingedly connected to the at least one door wing, wherein the two door wings are movable by the guide system between a first position, in which the two door wings are aligned substantially coplanar to each other, and a second position, in which the two door wings are aligned substantially parallel to each other.
